(19) United States
(12) Patent Application Publication
(10) Pub. No.: US 2013/0076183 A1
(43) Pub. Date: Mar. 28, 2013

(54) GRAVITY-ASSISTED SELF-ROTATING DEVICE AND POWER GENERATING MODULE USING SAME

(71) Applicant: Long Chang, Brooklyn, NY (US)

(72) Inventor: Long Chang, Brooklyn, NY (US)

(21) Appl. No.: 13/240,458

(22) Filed: Sep. 22, 2011

(51) Int. Cl. H02K 21/00; H01F 7/02

(52) U.S. Cl. 310/152; 335/306

(57) ABSTRACT

A gravity-assisted self-rotating device includes a support unit, a magnet unit located over the support unit, and a rotating unit pivotally turnably mounted on the support unit. The support unit has a bottom and a top extended in a direction opposite to the bottom. The magnet unit and the support unit together define a rotation space for the rotating unit to rotate therein. The gravity-assisted self-rotating device can be applied to a power generating module with a coil unit of the latter mounted on the rotating unit. With these arrangements, the gravity-assisted self-rotating device and the power generating module using same are able to automatically generate electric power output to achieve the purpose of energy saving and environmental protection.

### FIELD OF THE INVENTION

The present invention relates to a gravity-assisted self-rotating device, and more particularly to a gravity-assisted self-rotating device that enables automatic generation of electric power. The present invention also relates to an environmentally friendly power generating module that uses the above gravity-assisted self-rotating device to automatically generate electric power for supplying to an electronic device for use.

### BACKGROUND OF THE INVENTION

The currently available power generating devices generate electric power mainly through interaction between conductors and magnetic field. These power generating devices usually include a stator and a rotor rotatably arranged in the stator. The rotor is externally wound around by a plurality of induction coils, and the stator is provided on an inner wall surface with magnetic fields; or alternatively, a magnetic field is produced on the rotor and the stator is externally wound around by induction coils. When the rotor rotates, induction voltage is produced on the induction coils. The induction coil is externally connected to two conductors, so that electric current generated by the induction coil is transferred to other electric appliances for use.

The above-described power generating devices must be driven by hydraulic power or thermal power or be coupled with other rotary device for the rotor to rotate. That is, the conventional power generating devices tend to cause environmental disruption, air pollution or energy wasting, no matter in what manner the rotor of the power generating devices is driven to rotate. For instance, in the case of using thermal power to drive a conventional power generating device to generate electric power, it is necessary to continuously burn coal to generate thermal energy. In the process of burning coal, there would be constant waste gas emission to result in air pollution, making the power generating device environmentally hazardous.

Further, in the case of coupling a conventional power generating device with other rotary device to enable power generation, the rotary device must first be powered by some kind of energy source, such as electric power or gasoline, before it can drive the rotor of the power generating device to rotate. Therefore, the power generating device coupled with other rotary device apparently fails to meet the requirements of energy saving and environmental protection.

In brief, the conventional power generating devices have the following disadvantages: (1) unable to achieve effective energy saving; and (2) not environmentally friendly.

It is therefore tried by the inventor to develop a gravity-assisted self-rotating device and a power generating module using same to enable automatic generation of electric power and accordingly overcome the drawbacks of the conventional power generating devices.

### SUMMARY OF THE INVENTION

A primary object of the present invention is to provide a gravity-assisted self-rotating device, which is able to automatically generate power output to achieve the purpose of energy saving.

Another object of the present invention is to provide a gravity-assisted self-rotating device, which is able to automatically generate power output to achieve the purpose of environmental protection.

A further object of the present invention is to provide a power generating module that is able to automatically generate power output to achieve the purpose of energy saving.

A still further object of the present invention is to provide a power generating module that is able to automatically generate power output to achieve the purpose of environmental protection.

To achieve the above and other objects, the gravity-assisted self-rotating device according to the present invention includes a support unit, a magnet unit located over the support unit, and a rotating unit. The support unit has a bottom and a top extended in a direction opposite to the bottom. The magnet unit includes a first magnet section and a second magnet section. In a preferred embodiment of the present invention, the first magnet section is correspondingly connected to the support unit, and the second magnet is arranged on one face of the bottom of the support unit facing toward the rotating unit, such that the support unit and the magnet unit together define a rotation space between them.

The rotating unit is pivotally turnably mounted on the support unit to locate and rotate within the rotation space, and includes a first rotating arm, a second rotating arm and a plurality of first magnetic members. The first and the second rotating arm are separately outward extended from two opposite ends of the first magnetic members. The first rotating arm internally defines a first slide channel for receiving a second magnetic member therein; and the second rotating arm internally defines a second slide channel for receiving a third magnetic member therein.

With these arrangements, the gravity-assisted self-rotating device is able to automatically generate electric power output to achieve the purpose of energy saving and environmental protection.

To achieve the above and other objects, the power generating module according to the present invention includes a fixing unit, a coil unit, a second set of magnet unit, and a rotating device. The fixing unit includes a plurality of fixing members, on which the coil unit is supported. The coil unit includes a first wiring end and a second wiring end. The first wiring end is electrically connected to a first slip ring having a first carbon brush provided thereon; and the second wiring end is electrically connected to a second slip ring having a second carbon brush provided thereon. The second set of magnet unit includes a first magnet and an opposite second magnet being correspondingly arranged outside the coil unit. The rotating device includes a support unit, a magnet unit and a rotating unit. The support unit has a bottom and a top extended in a direction opposite to the bottom.

The magnet unit is located outside the support unit and includes a first magnet section and a second magnet section. The first magnet section is connected to the support unit, and the second magnet section is arranged on one face of the bottom of the support unit facing toward the rotating unit, such that the support unit and the magnet unit together define a rotation space there between for the rotating unit to rotate within the rotation space. The rotating unit is pivotally turnably mounted on the support unit to locate and rotate within the rotation space, and includes a first rotating arm, a second rotating arm, and a plurality of first magnetic members. The first and the second rotating arm are separately outward extended from two opposite ends of the first magnetic members; the first rotating arm internally defines a first slide channel for receiving a second magnetic member therein; and the second rotating arm internally defines a second slide channel for receiving a third magnetic member therein. The fixing unit is mounted to the rotating unit at positions adjacent to a center thereof.

With these arrangements, the power generating module is able to automatically generate electric power output to achieve the purpose of energy saving and environmental protection.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a gravity-assisted self-rotating device according to a first preferred embodiment of the present invention;

FIG. 2 is an exploded view of FIG. 1;

FIGS. 3 and 4 show the gravity-assisted self-rotating device of FIG. 1 in operation;

FIG. 5 shows a gravity-assisted self-rotating device according to a second preferred embodiment of the present invention in operation;

FIG. 6 is an assembled perspective view of a gravity-assisted self-rotating device according to a third preferred embodiment of the present invention being applied to a power generating module;

FIG. 7 is an exploded view of FIG. 6;

FIGS. 8 and 9 show the gravity-assisted self-rotating device of FIG. 6 in operation; and

FIG. 10 shows a gravity-assisted self-rotating device according to a fourth preferred embodiment of the present invention in operation being applied to a power generating module.

### DETAILED DESCRIPTION OF THE PREFERRED EMBODIMENTS

The present invention will now be described with some preferred embodiments thereof and with reference to the accompanying drawings. For the purpose of easy understanding, elements that are the same in the preferred embodiments are denoted by the same reference numerals.

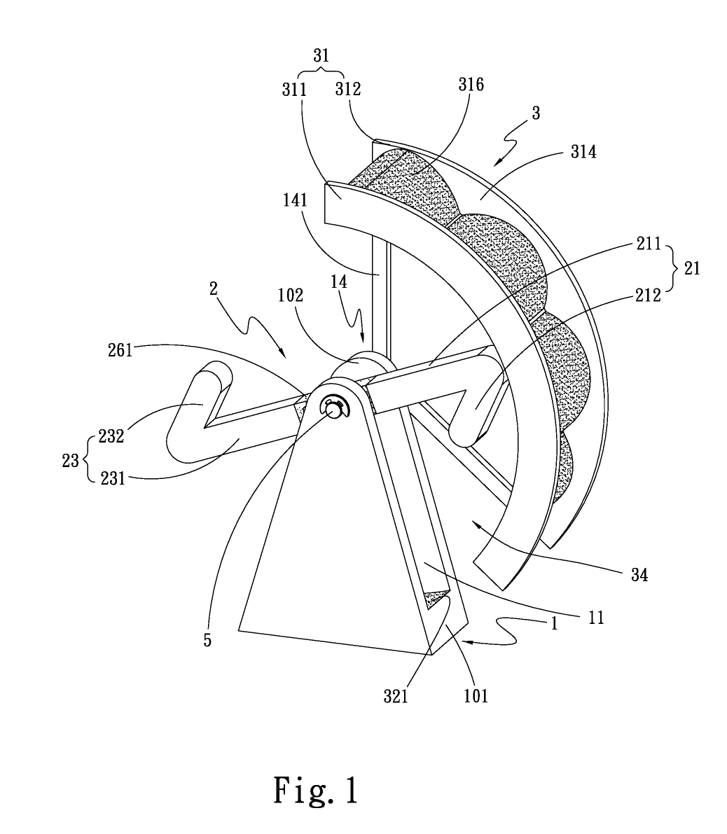

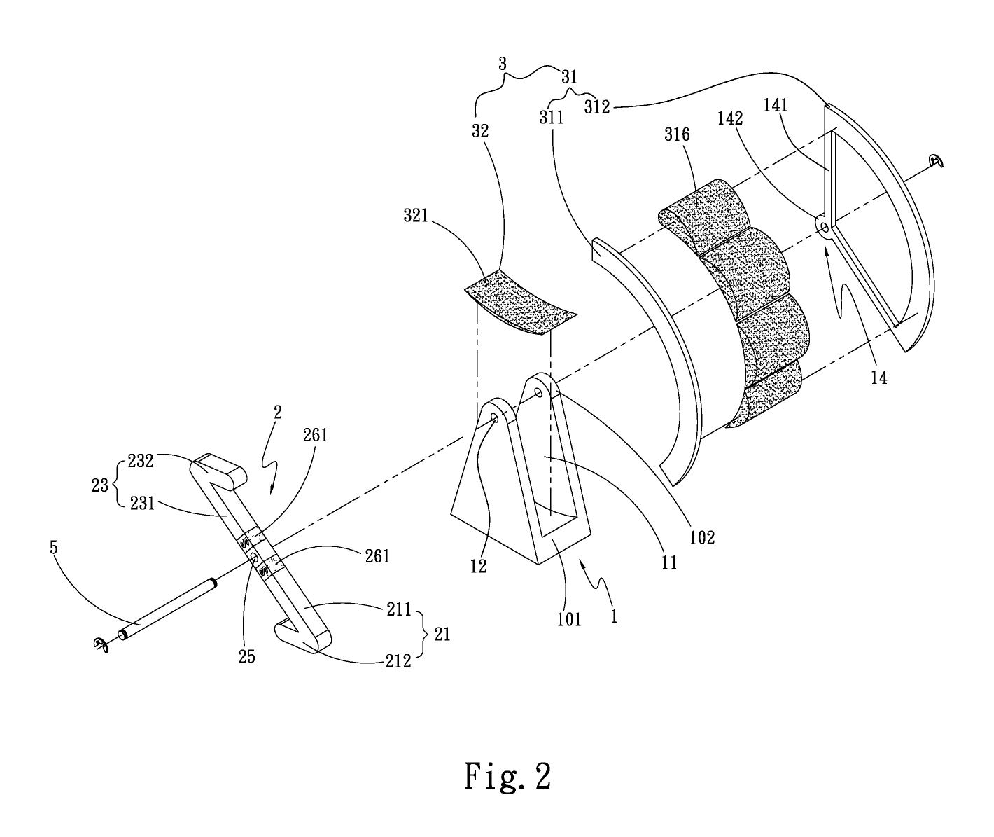

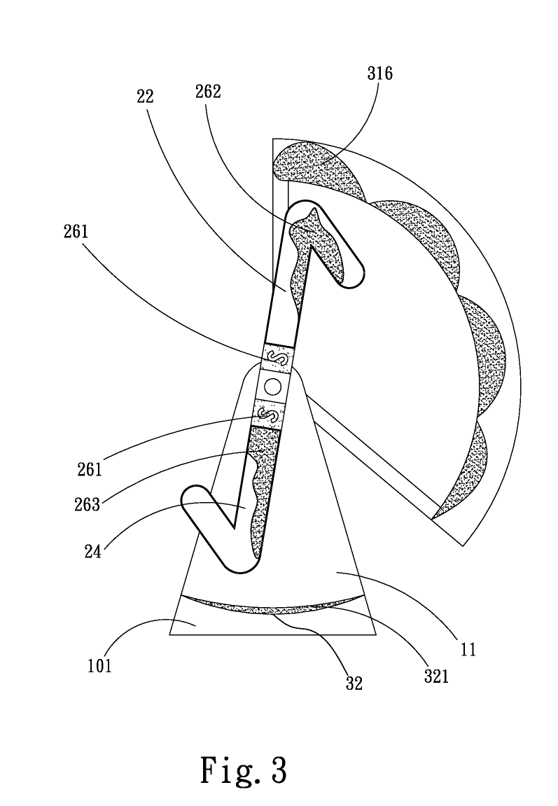

Please refer to FIGS. 1 and 2 that are assembled and exploded perspective views, respectively, of a gravity-assisted self-rotating device according to a first preferred embodiment of the present invention, and to FIG. 3 that is a sectional view showing the gravity-assisted self-rotating device of FIG. 1 in operation. As shown, the gravity-assisted self-rotating device of the present invention in the first embodiment thereof includes a support unit 1, a rotating unit 2, and a magnet unit 3. The support unit 1 is a framework having a bottom 101, a top 102 upward extended in a direction opposite to the bottom 101, an open space 11 formed between the bottom 101 and the top 102, a connecting section 14, and an axle hole 12 transversely extended through the top 102 to communicate with the open space 11. The connecting section 14 is mounted to a lateral outer side of the top 102. The connecting section 14 includes a base 142 and a plurality of arms 141 radially outward extended from outer periphery of the base 142. That is, the arms 141 are extended from the outer periphery of the base 142 to correspondingly connect to the magnet unit 3.

The open space 11 defines a path, along which the rotating unit 2 rotates on the support unit 1 around an axle 5 fixed in the axle hole 12 formed on the top 102. The axle 5 can be a pin or a rotary shaft.

Please refer to FIGS. 1 and 2 along with FIG. 3. The rotating unit 2 can be a rod or a blade without being particularly limited thereto, and is pivotally turnably mounted on the support unit 1 via the axle 5. It is noted the rotating unit 2 is located within a rotation space 34 defined between the magnet unit 3 and the support unit 1, so that the rotating unit 2 can rotate inertially in the rotation space 34 in a predetermined direction, such as clockwise or counterclockwise.

The rotating unit 2 includes a plurality of first magnetic members 261, a first rotating arm 21, and a second rotating arm 23. The first magnetic members 261 are located end to end, such that their facing ends are located adjacent to the axle hole 12, and the first and second rotating arms 21, 23 are separately outward extended from two opposite ends of the first magnetic members 261. The first and the second rotating arm 21, 23 internally define a first slide channel 22 and a second slide channel 24, respectively. That is, the first slide channel 22 is formed in the first rotating arm 21 for receiving a second magnetic member 262 therein, such that the second magnetic member 262 is displaceable in the first slide channel 22; and the second slide channel 24 is formed in the second rotating arm 23 for receiving a third magnetic member 263 therein, such that the third magnetic member 263 is displaceable in the second slide channel 24. In other words, the second and the third magnetic member 262, 263 are received in the first and the second slide channel 22, 24, respectively.

The first magnetic members 261 are permanent magnets. In the illustrated first preferred embodiment, the first magnetic members 261 are described as S-pole magnets without being limited thereto. That is, in practical implementation of the present invention, the first magnetic members 261 may be N-pole magnets. The second and the third magnetic member 262, 263 are liquid magnets without being limited thereto. In practical implementation of the present invention, the second and the third magnetic member 262, 263 can be any flowable magnet, such as magnetic powder. The facing ends of the first magnetic member 261 and the second magnetic member 262 magnetically attract each other. For instance, in the case the end of the first magnetic member 261 is N-pole, the end of the second magnetic member 262 facing toward the first magnetic member 261 is then S-pole. Similarly, the facing ends of another first magnetic member 261 and the third magnetic member 263 magnetically attract each other.

Please refer to FIG. 2 along with FIG. 3. The first rotating arm 21 includes a first linking section 211 and a first bent section 212. The first linking section 211 is extended between and connected to the first magnetic member 261 and the first bent section 212. The first slide channel 22 is formed in the first linking section 211 and the first bent section 212 of the first rotating arm 21. A pivot hole 25 is formed on the first magnetic members 261 corresponding to and communicating with the axle hole 12 on the support unit 1, and the axle 5 is sequentially extended through the axle hole 12 and the pivot hole 25.

The second rotating arm 23 includes a second linking section 231 and a second bent section 232. The second linking section 231 is extended between and connected to another first magnetic member 261 and the second bent section 232. The second slide channel 24 is formed in the second linking section 231 and the second bent section 232 of the second rotating arm 23.

The magnet unit 3 is connected to the support unit 1, and includes a first magnet section 31 and a second magnet section 32. The first magnet section 31 is connected to ends of the connecting arms 141 facing away from the support unit 1. In the illustrated first preferred embodiment, two connecting arms 141 are shown. More specifically, the two connecting arms 141 are connected at their radially outer ends to the first magnet section 31 and at their radially inner ends to the base 142, so that the first magnet section 31 is supported on the connecting arms 141 to thereby fixedly connect to and locate outside the support unit 1. The second magnet section 32 is arranged on one face of the bottom 101 facing toward the rotating unit 2.

As can be seen in FIGS. 1 and 2, the first magnet section 31 includes a first plate 311 and a second plate 312 arranged face to face and spaced from each other, such that a receiving space 314 is defined between the first plate 311 and the second plate 312 for receiving a plurality of fourth magnetic members 316 therein. The fourth magnetic members 316 can be permanent magnets or neodymium magnets, and are arranged in the receiving space 314 in particular order of their intensity of magnetic force as per designed. For example, in FIG. 1, a first one of the fourth magnetic members 316 at the twelve o'clock position has a magnetic force different from that of a second one of the fourth magnetic members 316 at the one o'clock position.

The second magnet section 32 includes at least one fifth magnetic member 321, which can be a permanent magnet or a neodymium magnet. The fifth magnetic member 321 is arranged on a closed side of the open space 11, i.e., one face of the bottom 101 facing toward the rotating unit 2.

In the illustrated first preferred embodiment, the fourth and the fifth magnetic members 316, 321 are shown as N-pole and S-pole magnetic members, respectively. That is, the fourth magnetic members 316 and the fifth magnetic members 321 are different in their polarity. Further, the first magnetic members 261 have a polarity the same as the fifth magnetic members 321 and different from the fourth magnetic members 316 without being limited thereto. In practical implementation of the present invention, the fourth magnetic members 316 may be changed from N-pole to S-pole while the first and the fifth magnetic members 216, 321 may be changed from S-pole to N-pole, depending on the working environment, location, and required rotating effect.

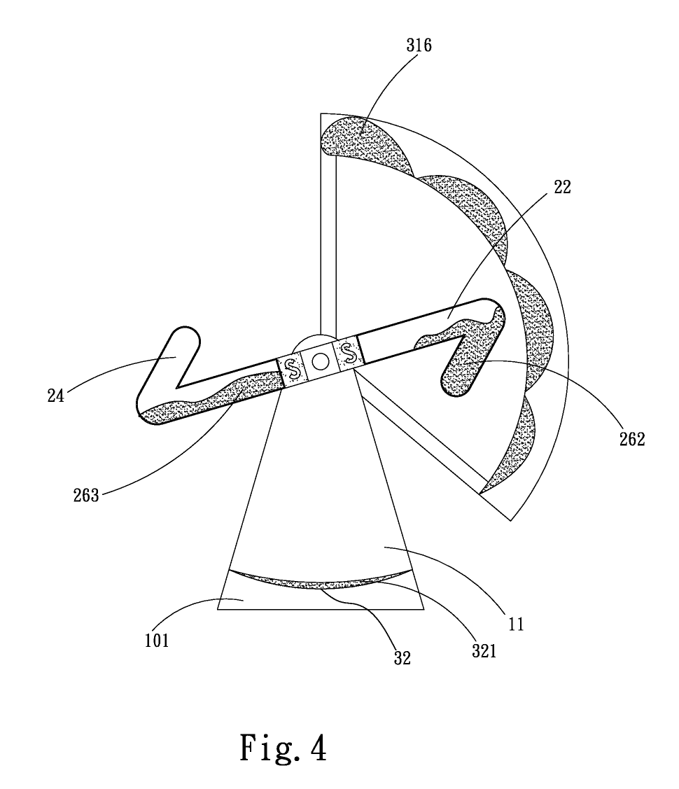

Please refer to FIGS. 1, 3 and 4 at the same time. When an external force is particularly applied to the first rotating arm 21 or the second rotating arm 23, or when the first rotating arm 21 or the second rotating arm 23 is subject to a natural push force, such as wind force, the rotating unit 2 will start rotating. When the first rotating arm 21 moves to a position corresponding to the first magnet section 31, a magnetic attraction force between the second magnetic member 262 in the first rotating arm 21 and the fourth magnetic members 316 of the first magnet section 31 is larger than the magnetic attraction force between the second magnetic member 262 and the first magnetic member 261. As a result, the second magnetic member 262 moves in the first slide channel 22 toward the fourth magnetic members 316 due to the stronger magnetic attraction between them. At this point, a part of the second magnetic member 262, i.e., part of the liquid magnet or the magnetic powder, flows into the first bent section 212 and falls down to a bottom end thereof under a gravity force, and is therefore less affected by the magnetic force of the fourth magnetic members 316. On the other hand, the rest part of the second magnetic member 262, i.e., the rest part of the liquid magnet or the magnetic powder, remains in the first linking section 211.

Meanwhile, the second rotating arm 23 moves to a position corresponding to the second magnet section 32. At this point, the third magnetic member 263 in the second rotating arm 23 and the fifth magnetic members 321 in the second magnet section 32 magnetically repulse each other, bringing the third magnetic member 263 to move in the second slide channel 24 away from the fifth magnetic members 321 toward a center between the first magnetic members 261. As a result, the third magnetic member 263, i.e., the liquid magnet or the magnetic powder, in the second linking section 231 and the second bent section 232 automatically flows to a position farther away from the fifth magnetic members 321 and closer to the first magnetic members 261. At this point, the third magnetic member 263 and the first magnetic members 261 magnetically attract each other, and a gravitational moment/torque of the first rotating arm 21 is larger than that of the second rotating arm 23, bringing down the rotating unit 2 and keep rotating clockwise due to inertia and accordingly produce kinetic energy output. In this manner, it is able to effectively achieve automatic generation of power output and consequently achieve the purpose of energy saving and environmental protection.

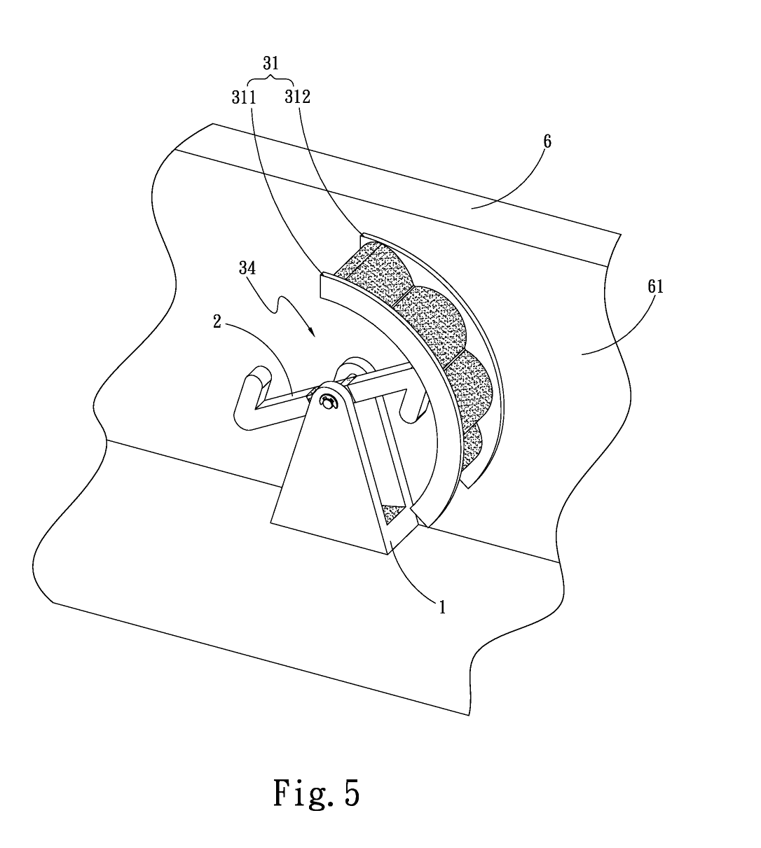

FIG. 5 is a perspective view of a gravity-assisted self-rotating device according to a second preferred embodiment of the present invention in operation. As shown, the gravity-assisted self-rotating device in the second embodiment is generally structurally similar to the first embodiment, except that, in the second embodiment, the connecting section 14 is omitted from the support unit 1 and the first magnet section 31 is fixedly mounted on a stationary structure 6, such as a wall surface, to correspondingly locate over the support unit 1. The stationary structure 6 has a mounting surface 61, on which the second plate 312 of the first magnet section 31 is fixedly mounted.

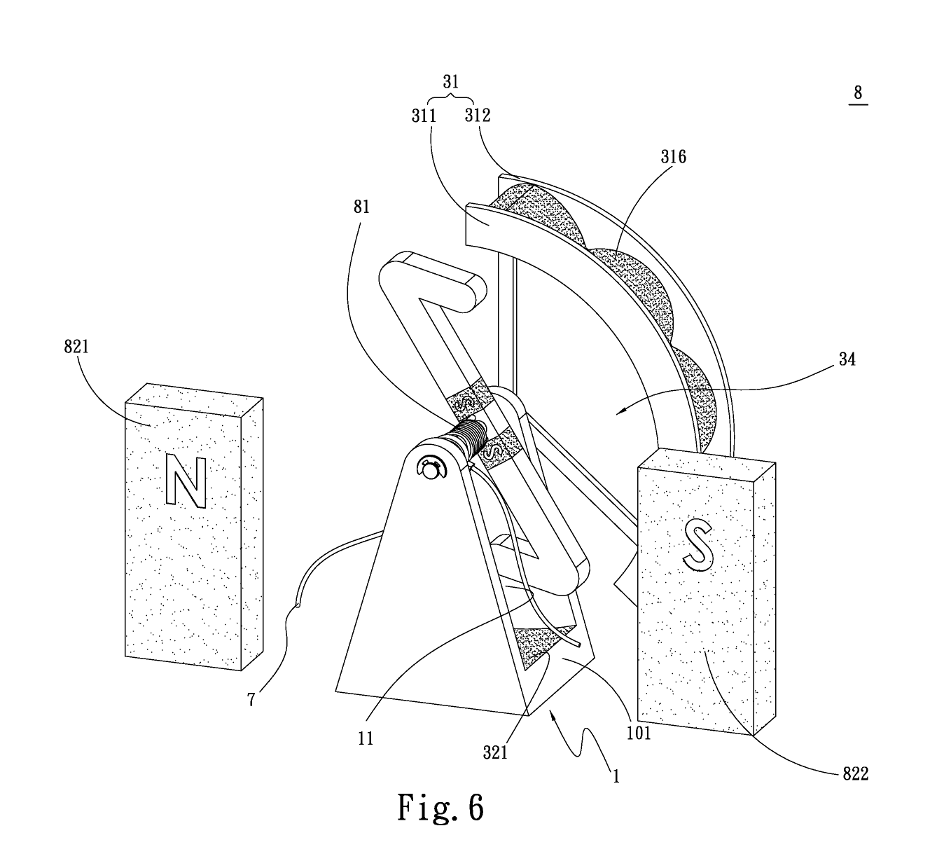

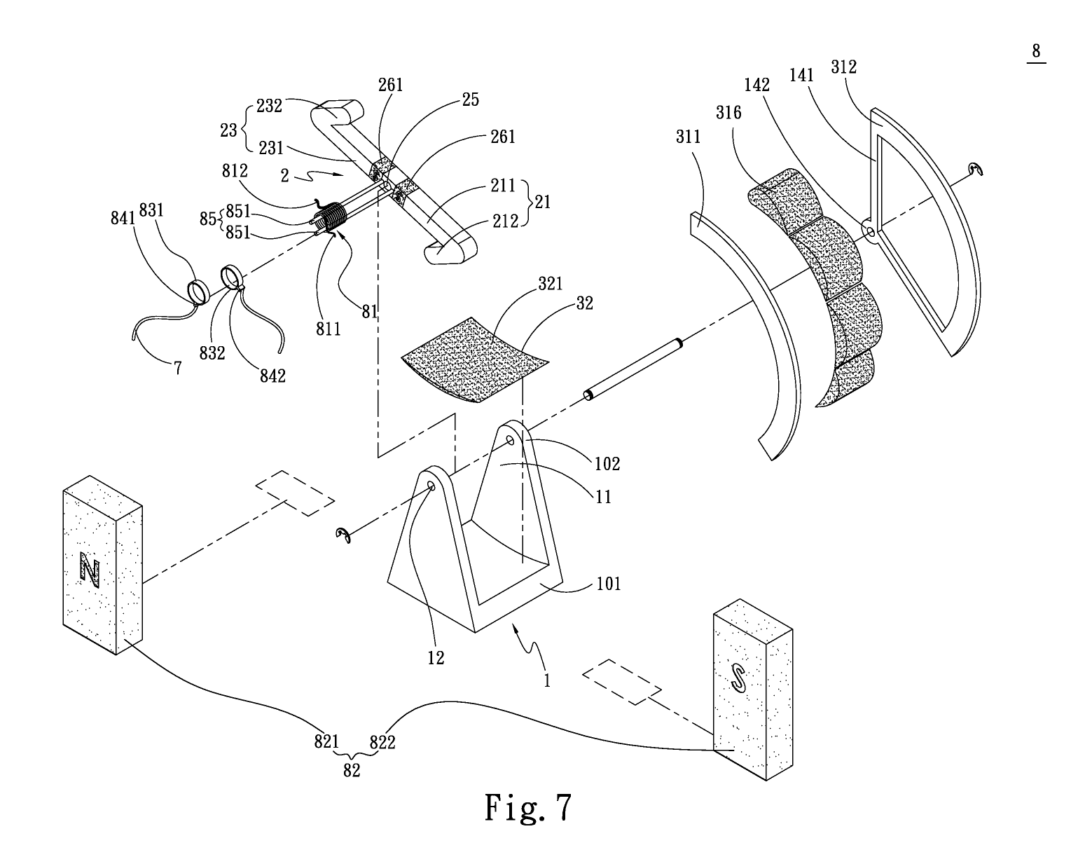

Please refer to FIGS. 6 and 7 that are assembled and exploded perspective views, respectively, of a gravity-assisted self-rotating device according to a third preferred embodiment of the present invention being applied to a power generating module 8. The power generating module 8 includes a coil unit 81, a second set of magnet unit 82, a rotating device, i.e., the gravity-assisted self-rotating device as generally described in the first preferred embodiment of the present invention, and a fixing unit 85. The fixing unit 85 includes a plurality of fixing members 851 for fixing and supporting the coil unit 81. The coil unit 81 is supported on the fixing unit 85 and includes a first wiring end 811 and a second wiring end 812. The first wiring end 811 is electrically connected to a first slip ring 831 having a first carbon brush 841 provided thereon, and the second wiring end 812 is electrically connected to a second slip ring 832 having a second carbon brush 842 provided thereon. And, the first and the second carbon brush 841, 842 are electrically connected to an output conductor group 7. With these arrangements, the first slip ring 831 can transfer electric current from the first wiring end 811 to the output conductor group 7 via the first carbon 841, and the second slip ring 832 can transfer electric current from the second wiring end 812 to the output conductor group 7 via the second carbon brush 842. Finally, the electric current received by the output conductor group 7 is supplied to an electronic device (not shown) for use.

Please refer to FIG. 7. The second set of magnet unit 82 includes a first magnet 821 and a second magnet 822 being correspondingly arranged outside the coil unit 81. In the illustrated preferred third embodiment, the first and the second magnet 821, 822 are fixedly located in the vicinity of the support unit 1 at two opposite ends thereof to correspond to the coil unit 81. The rotating device is generally structurally similar to the gravity-assisted self-rotating device according to the first preferred embodiment of the present invention, except that the rotating device in the third preferred embodiment has the fixing unit 85 mounted to the rotating unit 2 at positions adjacent to a center thereof. That is, the fixing members 851 are connected at their respective one end to positions adjacent to two laterally opposite ends of the pivot hole 25 on the first magnetic members 261, and at their respective another end to the coil unit 81.

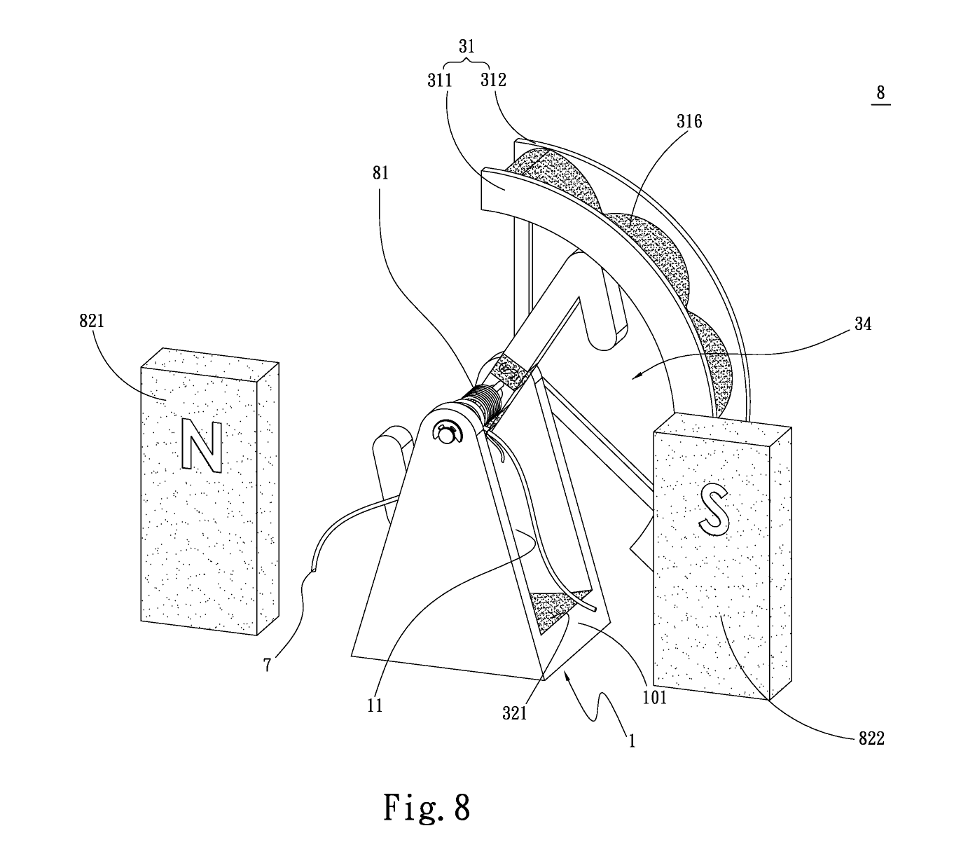

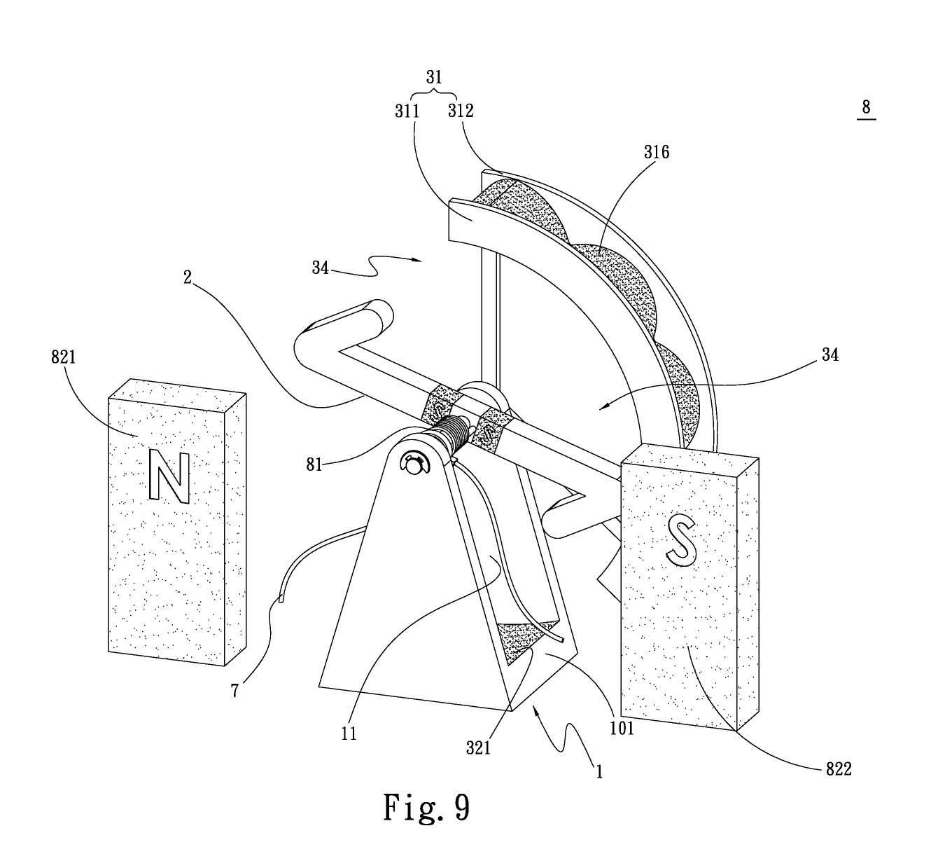

FIGS. 8 and 9 show the operation of the gravity-assisted self-rotating device according to the third preferred embodiment of the present invention. Please refer to FIGS. 6 and 7 along with FIGS. 8 and 9. When an external force is particularly applied to the first rotating arm 21 or the second rotating arm 23, or when the first rotating arm 21 or the second rotating arm 23 is subject to a natural push force, such as wind force, the rotating unit 2 will start rotating. When the first rotating arm 21 moves to a position corresponding to the first magnet section 31, a magnetic attraction force between the second magnetic member 262 in the first rotating arm 21 and the fourth magnetic members 316 of the first magnet section 31 is larger than the magnetic attraction force between the second magnetic member 262 and the first magnetic member 261. As a result, the second magnetic member 262 moves in the first slide channel 22 toward the fourth magnetic members 316 due to the stronger magnetic attraction between them. At this point, a part of the second magnetic member 262, i.e., part of the liquid magnet or the magnetic powder, flows into the first bent section 212 and falls down to a bottom end thereof under a gravity force, and is therefore less affected by the magnetic force of the fourth magnetic members 316. On the other hand, the rest part of the second magnetic member 262, i.e., the rest part of the liquid magnet or the magnetic powder, remains in the first linking section 211.

Meanwhile, the second rotating arm 23 moves to a position corresponding to the second magnet section 32. At this point, the third magnetic member 263 in the second rotating arm 23 and the fifth magnetic members 321 in the second magnet section 32 magnetically repulse each other, bringing the third magnetic member 263 to move in the second slide channel 24 away from the fifth magnetic members 321 toward a center between the first magnetic members 261. As a result, the third magnetic member 263, i.e., the liquid magnet or the magnetic powder, in the second linking section 231 and the second bent section 232 automatically flows to a position farther away from the fifth magnetic members 321 and closer to the first magnetic members 261.

At this point, the third magnetic member 263 and the adjacent first magnetic members 261 magnetically attract each other, and a gravitational moment/torque of the first rotating arm 21 is larger than that of the second rotating arm 23, bringing down the rotating unit 2 and keep rotating clockwise due to inertia. Meanwhile, the coil unit 81 mounted on the rotating unit 2 keeps cutting the magnetic lines between the first magnet 821 and the second magnet 822 to thereby produce induced current. The first slip ring 831 and the second slip ring 832 transfer the induced current from the first and the second wiring end 811, 812 to the output conductor group 7 via the first and the second carbon brush 841, 842, and the output conductor group 7 further supplies the received electric current to an electronic device for use. That is, the power generating module 8 with the gravity-assisted self-rotating device of the present invention is able to effectively supply electric power to an electronic device for use, so as to achieve the purpose of energy saving and environmental protection.

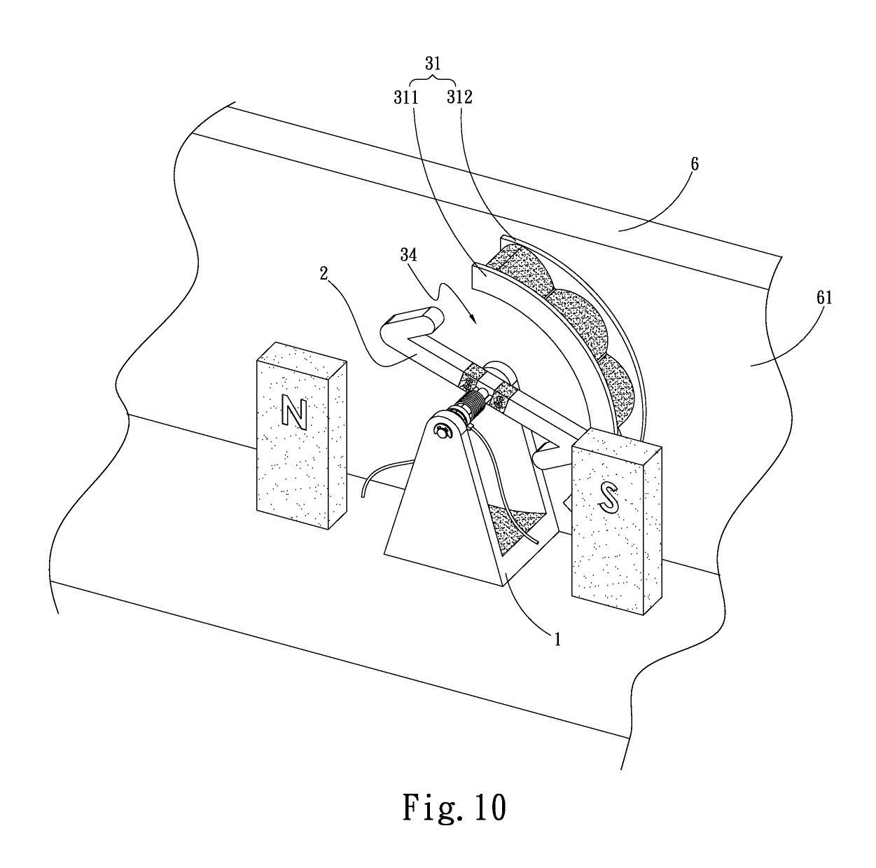

FIG. 10 is a perspective view of a gravity-assisted self-rotating device according to a fourth preferred embodiment of the present invention being applied to a power generating module 8. As shown, the gravity-assisted self-rotating device in the fourth embodiment is generally structurally similar to the third embodiment, except that, in the fourth embodiment, the connecting section 14 is omitted from the support unit 1 and the first magnet section 31 is fixedly mounted on a stationary structure 6, such as a wall surface, to correspondingly locate over the support unit 1. The stationary structure 6 has a mounting surface 61, on which the second plate 312 of the first magnet section 31 is fixedly mounted.

With the above arrangements, the present invention provides the following advantages: (1) enabling automatic generation of electric power for supplying to an electronic device for use; (2) enabling automatic generation of kinetic energy output; (3) achieving energy saving effect; and (4) being environmentally friendly.

The present invention has been described with some preferred embodiments thereof and it is understood that many changes and modifications in the described embodiments can be carried out without departing from the scope of the present invention is intended to be limited only by the appended claims.

What is claimed is:

1. A gravity-assisted self-rotating device, comprising:
a support unit having a bottom and a top upward extended in a direction opposite to the bottom;
a magnet unit including a first magnet section and a second magnet section; the first magnet section being correspondingly located over the support unit and the second magnet section being arranged on the bottom of the support unit, such that the support unit and the magnet unit together define a rotation space therebetween; and
a rotating unit being pivotally turnably mounted on the support unit to locate and rotate within the rotation space; the rotating unit including a first rotating arm, a second rotating arm, and a plurality of first magnetic members; the first and the second rotating arm being separately outward extended from two opposite ends of the first magnetic members; the first rotating arm internally defining a first slide channel for receiving a second magnetic member therein; and the second rotating arm internally defining a second slide channel for receiving a third magnetic member therein.

2. The gravity-assisted self-rotating device as claimed in claim 1, wherein the support unit has a connecting section mounted to a lateral outer side of the top, the connecting section including a plurality of radially outward extended arms, and the first magnet section being connected to radially outer ends of the arms of the connecting section.

3. The gravity-assisted self-rotating device as claimed in claim 2, wherein the support unit is a framework, and has an open space formed between the bottom and the top and an axle hole transversely extended through the top to communicate with the open space.

4. The gravity-assisted self-rotating device as claimed in claim 3, wherein the first rotating arm includes a first linking section and a first bent section; the first linking section being extended between and connected to the first magnetic member and the first bent section; and the first slide channel being formed in the first linking section and the first bent section of the first rotating arm; and whereof in between the first magnetic members there having a pivot hole formed thereat to correspond to and communicate with the axle hole formed on the top of the support unit; and an axle being sequentially extended through the axle hole and the pivot hole.

5. The gravity-assisted self-rotating device as claimed in claim 4, wherein the second rotating arm includes a second linking section and a second bent section; the second linking section being extended between and connected to the first magnetic member and the second bent section; and the second slide channel being formed in the second linking section and the second bent section of the second rotating arm.

6. The gravity-assisted self-rotating device as claimed in claim 2, wherein the connecting section includes a base, and the arms of the connecting section are radially outward extended from an outer periphery of the base.

7. The gravity-assisted self-rotating device as claimed in claim 3, wherein the first magnet section includes a first plate and a second plate arranged face to face and spaced from each other, so that a receiving space is defined between the first and the second plate for receiving a plurality of fourth magnetic members therein.

8. The gravity-assisted self-rotating device as claimed in claim 7, wherein the second magnet section includes at least one fifth magnetic member, which is arranged on a closed side of the open space.

9. The gravity-assisted self-rotating device as claimed in claim 7, wherein the fourth magnetic members are arranged in the receiving space in particular order of their intensity of magnetic force as per designed.

10. The gravity-assisted self-rotating device as claimed in claim 2, wherein the first magnetic members are permanent magnets.

11. The gravity-assisted self-rotating device as claimed in claim 1, wherein the second and the third magnetic member are selected from the group consisting of liquid magnet and magnetic powder; and wherein facing ends of one of the first magnetic members and the second magnetic member magnetically attract each other; and facing ends of another first magnetic member and the third magnetic member magnetically attract each other.

12. The gravity-assisted self-rotating device as claimed in claim 8, wherein the fourth and the fifth magnetic members are selected from the group consisting of permanent magnets and neodymium magnets; the fourth magnetic members and the fifth magnetic members are different in polarity; and the first magnetic members have a polarity the same as the fifth magnetic members and different from the fourth magnetic members.

13. The gravity-assisted self-rotating device as claimed in claim 1, wherein the first magnet section is provided on a stationary structure having a mounting surface, on which the first magnet section is fixedly mounted.

14. A power generating module, comprising:
a fixing unit including a plurality of fixing members;
a coil unit being supported on the fixing unit, and including a first wiring end and a second wiring end; the first wiring end being electrically connected to a first slip ring having a first carbon brush provided thereon; the second wiring end being electrically connected to a second slip ring having a second carbon brush provided thereon;
a second set of magnet unit including a first magnet and an opposite second magnet, which are correspondingly located outside the coil unit; and
a rotating device including:
a support unit having a bottom and a top upward extended in a direction opposite to the bottom;
a magnet unit including a first magnet section and a second magnet section; the first magnet section being correspondingly located over the support unit and the second magnet section being arranged on the bottom of the support unit, such that the support unit and the magnet unit together define a rotation space therebetween; and
a rotating unit being pivotally turnably mounted on the support unit to locate and rotate within the rotation space; the rotating unit including a first rotating arm, a second rotating arm, and a plurality of first magnetic members; the first and the second rotating arm being separately outward extended from two opposite ends of the first magnetic members; the first rotating arm internally defining a first slide channel for receiving a second magnetic member therein; and the second rotating arm internally defining a second slide channel for receiving a third magnetic member therein; and
wherein the fixing unit is mounted to the rotating unit at positions adjacent to a center thereof.
